(19) United States
(12) Patent Application Publication
(10) Pub. No.: US 2022/0042789 A1
(43) Pub. Date: Feb. 10, 2022

(54) PORTABLE TRUSS STRUCTURE EXPERIMENT DEVICE

(71) Applicant: DALIAN UNIVERSITY OF TECHNOLOGY, Dalian, Liaoning (CN)

(72) Inventors: Tingguo CHEN, Dalian, Liaoning (CN); Zinan LIU, Dalian, Liaoning (CN); Guanning DONG, Dalian, Liaoning (CN); Chengjiao REN, Dalian, Liaoning (CN); Deqing ZHU, Dalian, Liaoning (CN); Weibin REN, Dalian, Liaoning (CN); Jianglong WU, Dalian, Liaoning (CN)

(21) Appl. No.: 17/280,107

(22) PCT Filed: Sep. 28, 2020
(86) PCT No.: PCT/CN2020/118282

§ 371 Date: Mar. 25, 2021

(30) Foreign Application Priority Data
May 27, 2020 (CN) 202010462078.0

(51) Int. Cl. G01B 11/16; G09B 23/10

(52) U.S. Cl. CPC G01B 11/16; G09B 23/10

(57) ABSTRACT

A portable truss structure experiment device, belonging to the field of teaching practice in structural mechanics of Civil Engineering. The device comprises a basic framework, detachable beams, locating rods, a slide rail, hinge supports, a truss structure, reflectors, measurement apparatuses and a collection apparatus. The device has the advantages of simple structure, convenient assembly and disassembly, reuse, accurate measurement result, can be synchronized to a large screen to directly obtain a structure influence line, and can implement classroom demonstration of the teaching content of an influence line in structure mechanics. Through experiments, students can understand relevant theories of the influence line in structural mechanics more accurately.

### TECHNICAL FIELD

The present disclosure belongs to the field of teaching practice of structural mechanics of Civil Engineering, and relates to a determinate truss structure experiment device which can be used to carry out classroom demonstration experiments of truss influence lines in structural mechanics.

### BACKGROUND

As a compulsory subject of Civil Engineering in colleges and universities in which beam, arch, truss, rigid frame and other structures of bar system are taken as main research objects, structural mechanics studies internal force and deformation of a structure under the action of external force and other external factors, the strength, rigidity, stability and dynamic response of the structure, and the formation rule and mechanical behavior of the structure according to the mechanics principle.

Theory teaching, as a main teaching method for structural mechanics in colleges and universities at present, lacks experimental verification of relevant mechanics principles, which leads some students to understand relevant theories insufficiently, and even to question the relevant theories. Therefore, it is an inevitable trend to introduce experiment links in the teaching of structural mechanics.

In the influence line part in the teaching of structural mechanics, a truss structure is often taken as a research object. However, most truss structure models in laboratory are bulky and then are not suitable for being used in class. Therefore, it is especially important to invent a truss structure model which is easy to disassemble and convenient to carry to study the relevant theories of influence lines in structural mechanics.

### SUMMARY

In order to change the present situation of lacking the experiment demonstrations of influence lines in classroom teaching of structural mechanics at present, a portable truss structure experiment device is invented. The device has the advantages of simple structure, convenient assembly and disassembly, reuse, accurate measurement result, can be synchronized to a large screen to directly obtain the structural influence lines, and can implement classroom demonstrations of influence lines in the teaching of structural mechanics. Through experiments, students can understand relevant theories of the influence lines in structural mechanics more accurately.

The technical solution of the present disclosure is:

A portable truss structure experiment device, comprising a basic framework 1, detachable beams 2, locating rods 3, a slide rail 4, hinge supports 5, a truss structure, reflectors 13, measurement apparatuses and a collection apparatus, wherein the basic framework 1 guarantees the stability of the whole device by self-weight; the detachable beams 2 are two in number, each detachable beam 2 is connected with a locating rod 3, the locating rods 3 are perpendicular to a base of the basic framework 1, and the two detachable beams 2 are perpendicular to two stand columns of the basic framework 1 respectively; the slide rail 4 is fixed to one detachable beam 2; the hinge supports 5 are two in number and are fixed to the other detachable beam 2 and the slide rail 4 respectively, and the two hinge supports 5 are located at the same level; the truss structure comprises fixed length rods, telescopic rods and hinge joints 6, wherein each fixed length rod is formed by combining a pair of sheet steels 7 to guarantee the spatial stability of the model; each telescopic rod comprises an adjusting screw 9, a dial 10, a pointer 14, two clamping devices 8 and two pairs of sheet steels 7, wherein each pair of sheet steels 7 of the telescopic rod are fixed into a whole by one clamping device 8, both ends of the adjusting screw 9 are connected to the two clamping devices 8, the pointer 14 is fixed to the clamping devices 8, the dial 10 is fixed to the adjusting screw 9, the adjusting screw 9 is rotated so the length of the rod is adjusted and the rotation angle of the adjusting screw 9 is read, and thus the variation of length of the rod is calculated; all the fixed length rods and telescopic rods are connected into a whole by the hinge joints 6, each hinge joint 6 is fixed with a reflector 13 to reflect laser emitted by laser displacement sensors 11; the measurement apparatuses are the laser displacement sensors 11 and are used to measure the displacement of each joint of the model; the collection apparatus is a multi-mode structural parameter telemetry system terminal and is used to collect the displacement of each joint of the model; the laser displacement sensors 11 are fixed to the beams and base of the basic framework 1 by mounting plates 12, are vertically aligned with the hinge joints 6 in position respectively, and are used to measure the displacement of the hinge joints 6 of the model; and the collection apparatus is a multi-mode structural parameter telemetry system terminal and is used to collect the displacement of each joint of the model.

The present disclosure has the advantageous effects that: the portable truss structure experiment device manufactured according to the present disclosure integrates convenience and scientificity, can be used to carry out real experiments and can be used to immediately process experimental results, is suitable for demonstration in class with limited time; and the experiment device is simple in operation, easy for beginners to learn, and suitable for students to operate.

### DESCRIPTION OF DRAWINGS

FIG. 1 is a front view of a portable truss structure experiment device of the present disclosure.

FIG. 2 is a side view of a portable truss structure experiment device of the present disclosure.

FIG. 3 is a top view of a portable truss structure experiment device of the present disclosure.

In the figures: 1. basic framework; 2. detachable beam; 3. locating rod; 4. slide rail; 5. hinge support; 6. hinge joint; 7. sheet steel; 8. clamping device; 9. adjusting screw; 10. dial; 11. laser displacement sensor; 12. mounting plate; 13. reflector; 14. pointer.

### DETAILED DESCRIPTION

The present disclosure is further described in detail below in combination with the drawings.

The present disclosure: a portable truss structure experiment device, comprising a basic framework 1, two detachable beams 2, two locating rods 3, a slide rail 4, two hinge supports 5, ten fixed length rods, three telescopic rods, six hinge joints 6, six reflectors 13, measurement apparatuses and a collection apparatus.

The device is specifically installed as follows:

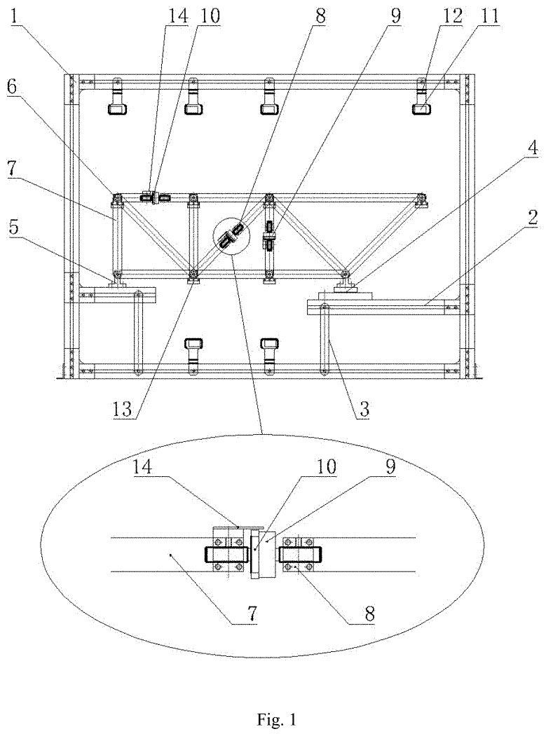

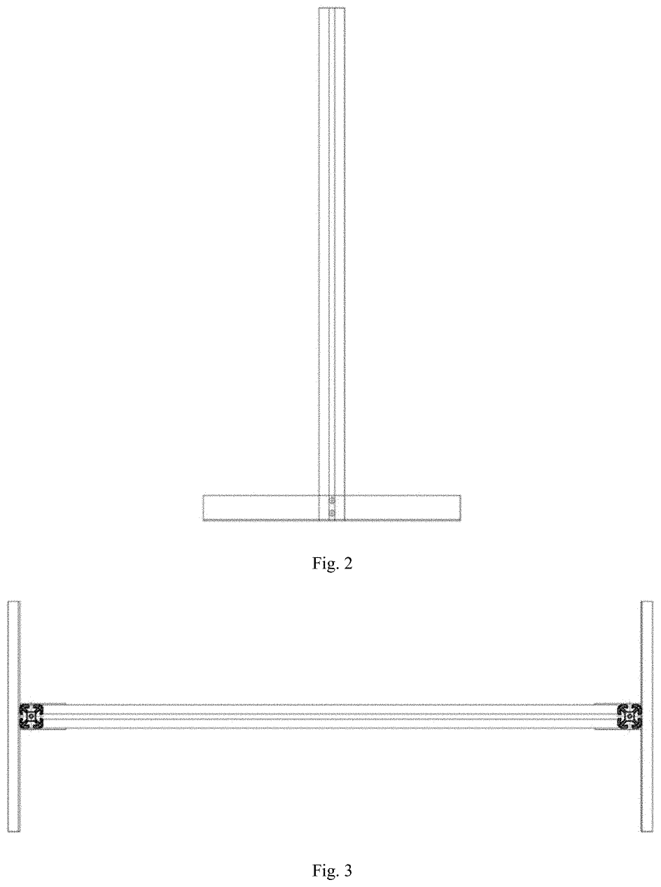

FIG. 1 is a front view of a portable truss structure experiment device of the present disclosure; FIG. 2 is a side view of a portable truss structure experiment device of the present disclosure; and FIG. 3 is a top view of a portable truss structure experiment device of the present disclosure.

As shown in FIG. 1, FIG. 2 and FIG. 3, the basic framework 1 guarantees the stability of the whole device by self-weight; the two detachable beams 2 are respectively fixed to two stand columns and a base of the basic framework 1 by respective locating rods 3, wherein the locating rods 3 are perpendicular to the base of the basic framework 1, and the two detachable beams 2 are perpendicular to the two stand columns of the basic framework 1 respectively; the slide rail 4 is fixed to the long detachable beam 2; and the two hinge supports 5 are fixed to the short detachable beam 2 and the slide rail 4 respectively.

Each of the ten fixed length rod is formed by combining a pair of sheet steels 7 to guarantee the spatial stability of the model. Each of the three telescopic rods comprises two pairs of sheet steels 7, two clamping devices 8, an adjusting screw 9, a pointer 14, and a dial 10, wherein each pair of sheet steels 7 are fixed into a whole by one clamping device 8, both ends of the adjusting screw 9 are connected to the two clamping devices 8, the pointer 14 is fixed to the clamping devices 8, the dial 10 is fixed to the adjusting screw 9, the adjusting screw 9 is rotated so the length of the rod is adjusted and the rotation angle is read, and thus the variation of length of the rod is calculated. In the case where the adjusting screw 9 is rotated 60° each time, the length of the rod is changed by 0.5 mm.

All the rods are connected with the two hinge supports 5 into a whole by the six hinge joints 6, each hinge joint 6 is fixed with a reflector 13 to reflect laser emitted by laser displacement sensors 11; the six laser displacement sensors 11 are fixed to the beams and base of the basic framework 1 by the mounting plates 12, are vertically aligned with the six hinge joints 6 in position respectively, and are used to measure the displacement of the hinge joints 6 of the model; and the collection apparatus is a multi-mode structural parameter telemetry system terminal and is used to collect the displacement of each joint of the model.

As shown in FIG. 1, the fixed length rods include six short rods and three medium-long rods, which are respectively used as the right-angle side and hypotenuse of an isosceles right triangle, and one long rod which is twice as long as the short one; the telescopic rods include two short rods and one medium-long rod, and the initial length of the telescopic rods shall be adjusted to be the same as the that of corresponding fixed length rods before assembly.

Experimental steps for making an influence line of a truss structure using the kinematic method are as follows:

Step 1. installing the portable truss structure experiment device according to the above method, energizing the laser displacement sensors 11 and the multi-mode structural parameter telemetry system terminal, and marking three telescopic rods, wherein the transverse rod is marked as 1st rod, the vertical rod is marked as 2nd rod, and the inclined rod is marked as 3rd rod.

Step 2. keeping the length of the 2nd and 3rd rods unchanged, rotating the adjusting screw 9 to elongate the 1st rod, conducting preloading, and balancing the multi-mode structural parameter telemetry system terminal.

Step 3. keeping the length of the 2nd and 3rd rods unchanged, rotating the adjusting screw 9 to elongate the 1st rod, rotating 60° each stage, keeping an interval of at least 5 seconds between two stages of loading to guarantee the data's stability of the laser displacement sensors, and collecting displacement data.

Step 4. post-processing the collected data, obtaining an influence line of the 1st rod.

Step 5. conducting unloading, keeping the length of the 2nd and 3rd rods unchanged, and reversely rotating the adjusting screw 9 to recover the model to a state before assembling.

Step 6. keeping the length of the 1st and 3rd rods unchanged, and repeating steps 2 to 5.

Step 7. keeping the length of the 1st and 2nd rods unchanged, and repeating steps 2 to 5.

1. A portable truss structure experiment device, comprising a basic framework (1), detachable beams (2), locating rods (3), a slide rail (4), hinge supports (5), a truss structure, reflectors (13), measurement apparatuses and a collection apparatus, wherein the basic framework (1) guarantees the stability of the whole device by self-weight; the detachable beams (2) are two in number, each detachable beam (2) is connected with a locating rod (3), the locating rods (3) are perpendicular to a base of the basic framework (1), and the two detachable beams (2) are perpendicular to two stand columns of the basic framework (1) respectively; the slide rail (4) is fixed to one detachable beam (2); the hinge supports (5) are two in number and are fixed to the other detachable beam (2) and the slide rail (4) respectively, and the two hinge supports (5) are located at the same level; the truss structure comprises fixed length rods, telescopic rods and hinge joints (6), wherein each fixed length rod is formed by combining a pair of sheet steels (7) to guarantee the spatial stability of the model; each telescopic rod comprises an adjusting screw (9), a dial (10), a pointer (14), two clamping devices (8) and two pairs of sheet steels (7), wherein each pair of sheet steels (7) of the telescopic rod are fixed into a whole by one clamping device (8), both ends of the adjusting screw (9) are connected to the two clamping devices (8), the pointer (14) is fixed to the clamping devices (8), the dial (10) is fixed to the adjusting screw (9), the adjusting screw (9) is rotated so the length of the rod is adjusted and the rotation angle of the adjusting screw (9) is read, and thus the variation of length of the rod is calculated; all the fixed length rods and telescopic rods are connected into a whole by the hinge joints (6), each hinge joint (6) is fixed with a reflector (13) to reflect laser emitted by laser displacement sensors (11); the measurement apparatuses are the laser displacement sensors (11) and are used to measure the displacement of each joint of the model; the collection apparatus is a multi-mode structural parameter telemetry system terminal and is used to collect the displacement of each joint of the model; the laser displacement sensors (11) are fixed to the beams and base of the basic framework (1) by mounting plates (12), are vertically aligned with the hinge joints (6) in position respectively, and are used to measure the displacement of the hinge joints (6) of the model; and the collection apparatus is a multi-mode structural parameter telemetry system terminal and is used to collect the displacement of each joint of the model.
